(19) United States
(12) Patent Application Publication
(10) Pub. No.: US 2021/0186009 A1
(43) Pub. Date: Jun. 24, 2021

(54) DUST FORMULATION COMPRISING A CARRIER TO WHICH ACTIVE INGREDIENTS ARE APPLIED VIA A SOLVENT

(71) Applicant: Bayer CropScience LP, St. Louis, MO (US)

(72) Inventors: Alexander KO, Durham, NC (US); Kyle DENK, Chesterfield, MO (US)

(21) Appl. No.: 17/123,729

(22) Filed: Dec. 16, 2020

Related U.S. Application Data
(60) Provisional application No. 62/950,839, filed on Dec. 19, 2019.

(30) Foreign Application Priority Data
Jan. 8, 2020 (EP) 20150685.4

(51) Int. Cl. A01N 25/04; A01N 25/30; A01N 43/50; A01N 43/88; A01N 43/40; A01N 43/08; A01N 43/78; A01N 37/38

(52) U.S. Cl. CPC A01N 25/04; A01N 25/30; A01N 43/50; A01N 37/38; A01N 43/40; A01N 43/08; A01N 43/78; A01N 43/88

(57) ABSTRACT

The disclosure provides for insecticidal compositions capable of controlling insects including bed bugs. The disclosure further provides for methods of applying insecticidal compositions described herein to control insects, including bed bug infestations. The disclosure further provides for methods of making insecticidal compositions useful for controlling insects including bed bugs.

### CROSS-REFERENCE TO RELATED PATENT APPLICATIONS

This patent application claims priority to U.S. Provisional Patent Application No. 62/950,839, filed Dec. 19, 2019 and European Patent Application No. 20150685.4, filed Jan. 8, 2020, the disclosures of each of which are herein incorporated in their entireties.

### FILED

The disclosure provides for insecticidal compositions capable of controlling insects including bed bugs. The disclosure further provides for methods of applying insecticidal compositions described herein to control insects, including bed bug infestations. The disclosure further provides for methods of making insecticidal compositions useful for controlling insects including bed bugs.

### BACKGROUND

There is an ongoing need for compositions and methods capable of effectively controlling bed bugs.

Bed bugs have been known parasites for thousands of years and feed on blood. Treatment of bed bug bites is directed toward management of the symptoms. Patient responses to bites vary, ranging from no visible effect, to small macular spots, to prominent wheals and bullae formations accompanied by intense itching that may persist several days.

A central spot of bleeding may also occur, triggered by the release of anticoagulants in the insects' saliva. Symptoms may not appear until some days after the bites have occurred, and reactions often occur more immediately after exposure after multiple bites, possibly due to sensitization to the bed bug's anticoagulating salivary proteins. Skin reactions typically occur in the area of the bite which is most commonly one's arms, shoulders and legs. Numerous bites may lead to an erythematous rash or urticaria.

More severe bed bug infestations and chronic bites have been known to, in some patients, cause anxiety, stress, and insomnia. Development of refractory delusional parasitosis is possible, as a patient develops an overwhelming obsession with bed bugs. Accordingly, improved methods and compositions for the control of bed bugs in the home and hotels is needed.

Eliminating bed bugs from the home is often difficult, in part because bed bugs can survive up to a year without feeding. Repeated treatments of the infested area may be required. Traditionally, such treatments may include heating the room to 57° C. (or 135° F.) or 60° C. (140° F.) for 6-8 hours, frequent vacuuming, drying/washing clothing at high temperatures, and the use of various pesticides.

Bed bug infestations are a global problem, occurring in all habitable regions and especially in densely populated areas. Bed bug infestations are relatively common, particularly since the 1990s. Possible contributing factors include significantly increased rates of human travel and relocation, an increased frequency in the exchange of secondhand furnishings such as mattresses and sofas, a greater focus on the control of other more harmful pests, and an ever-increasing resistance to pesticides.

Bed bug control is vital to the hospitality industry. According to a 2017 survey, 80% of hotels had dealt with bed bugs in the previous year and approximately 40% had treated for bed bugs within the previous month. Ongoing monitoring and treatment for bed bugs is routine and costly. Hotels spend, on average, $6,383 per bed bug incident. Common costs associated with bed bug infestations include replacement of soft-goods, treatment, and lost business.

Furthermore, almost half of all hotels have been subjected to litigation over bed bug infestations, costing on average over $17,000 per incident and as high as about $240,000 in total for litigation and remediation costs for a single bed bug incident. Moreover, hotels, on average, treat for bed bugs about seven times every five years.

While bed bug resistance to active ingredients is not a new phenomenon, reports of resistance to bed bug spray formulations is a troubling development. Increasing numbers of reports of bed bug resistance to modern insecticidal solutions only highlight the fact that a product that could break bed bug resistance is urgently needed.

Various suspension concentrate products have been developed to control bed bugs, including TEMPRID®, TANDEM®, TRANSPORT® MIKRON™, and CROSSFIRE®. These formulations have had limited effectiveness against strains of highly resistant bed bugs. Although active ingredient combination products have had varying degrees of success in the past, bed bugs have an inherent propensity to develop resistance to active ingredients, even when used in combination.

The present inventors have found that methods and formulations described herein exhibit unexpected efficacy in controlling insects, including bed bugs which have developed resistance to many existing methods of treatment.

### SUMMARY

The inventors of the present disclosure have found that compositions and methods described herein exhibit surprising control of insects including bed bugs.

In some embodiments, the disclosure provides for insecticidal compositions comprising:

(a) at least one active insecticidal ingredient and

(b) at least one carrier.

In some embodiments, the composition further comprises:

(c) at least one solvent and

(d) at least one surfactant.

In some embodiments, the disclosure provides for a method of controlling insects comprising applying to an insect, surface, or object to be treated a dustable insecticidal composition comprising the compositions disclosed herein.

In some embodiments, the disclosure provides for a method of controlling insects comprising applying to an insect, surface, or object to be treated a sprayable dust insecticidal composition comprising the compositions disclosed herein diluted with water.

In some embodiments, the disclosure provides for a method of preparing a dustable insecticidal composition comprising:

in a first step, preparing an emulsifiable concentrate comprising:
(a) at least one surfactant;
(b) at least one solvent; and
(c) at least one active insecticidal ingredient; and in a second step, adding at least one carrier to the emulsifiable concentrate and suspending the carrier into the emulsifiable concentrate.

In some embodiments, the disclosure provides for a method of preparing a sprayable dust insecticidal composition comprising:

in a first step, preparing an emulsifiable concentrate comprising:
(a) at least one surfactant;
(b) at least one solvent; and
(c) at least one active insecticidal ingredient; and

in a second step, adding at least one carrier to the emulsifiable concentrate and suspending the carrier into the emulsifiable concentrate; and

in a third step, diluting the emulsifiable concentrate in water or other solvent.

In some embodiments, the active ingredient is a sodium channel blocker.

In some embodiments, the active ingredient is a nicotinic receptor agonist.

In some embodiments, the insecticidal composition comprises a combination of one or more sodium channel blockers.

In some embodiments, the insecticidal composition comprises a combination of one or more nicotinic receptor agonists.

In some embodiments, the insecticidal composition comprises a combination of one or more sodium channel blockers and one or more nicotinic receptor agonists.

In some embodiments, the carrier is an inert carrier which has been shown to possess insecticidal activity, i.e., desiccating properties, abrasive properties, heat properties, etc.

In some embodiments, the insecticidal composition is micronized or solubilized onto the carrier particles.

### BRIEF DESCRIPTION OF THE DRAWINGS

FIG. 1 shows the difference in residual insecticidal activity of the liquid dust formulation against the comparative formulation without the inclusion of dust as described in Table 1.

FIG. 2 shows a comparison of formulations having the same concentration of active ingredient, the only difference being the inclusion of the dust in the liquid dust formulation (named KTD-1C).

FIG. 3 shows a comparison of sprays having identical levels of active ingredient, the only difference being the inclusion of dust into the liquid dust formulation (named KTD-1C).

### DETAILED DESCRIPTION

The inventors of the present disclosure have found that compositions and methods described herein exhibit surprising control of insects including bed bugs.

Bed bugs have an inherent propensity to develop resistance to active ingredients (ai), even when used in combination. However, bed bugs have not yet developed significant resistance to physical modes of action such as heat, desiccation, and/or abrasion. The present invention therefore represents a proactive response to the growing threat of bed bug resistance in the pest control industry.

Dustable formulations have also been developed in the industry to combat resistant bed bugs with various modes of action, such as the desiccating properties of silica aerogel (e.g., CimeXa) or the abrasive properties of diatomaceous earth. These presently available dustable formulations have some efficacy against resistant bed bugs due to their alternative modes of action (e.g., damaging bed bug cuticles through physical means rather than physiological effect on the nervous system), but lack the “speed of kill” one would desire from a traditional suspension concentrate formulation.

For example, the inventors of the present disclosure have found that dustable powder insecticidal formulations differ in bioavailability, and thus differ in efficacy, from traditional insecticidal suspension concentrate formulations. Also, while insecticidal dusts generally have a high degree of efficacy against insects, the application of such dusts have traditionally been a labor-intensive process involving hand puffers requiring the pest control operator to crawl underneath difficult to reach areas to apply the product. On the other hand, traditional spray products are easy to apply but lack the bioavailability and residuality of traditional dust products.

The inventors of the present disclosure have found that, in certain embodiments, combining dustable powders with suspension concentrates can achieve improved bed bug control relative to existing compositions and methods. The incorporation of an insecticidal dust into an emulsifiable concentrate sprayable product increases the accessibility of dust applications into traditional spray services. The present invention also allows for the liquid spray application of the insecticidal dust, which is significantly less labor-intensive than traditional dust applications. Additionally, liquid spray deposition allows for an even distribution of the product on a surface, relative to that of a dust.

The inventors found, therefore, that dustable powder compositions described herein, and methods of using and applying the same, exhibit surprisingly improved control of insects including bed bugs relative to existing compositions and methods. The described invention bridges the gap between traditional spray products and traditional dust products.

Compositions and methods of the present invention described herein possess multiple modes of action to overcome resistance exhibited by some special strains of pests, such as bed bugs.

In some embodiments, the disclosure provides for insecticidal compositions comprising: (a) at least one active insecticidal ingredient and (b) at least one carrier.

In some embodiments, the composition further comprises: (c) at least one solvent and (d) at least one surfactant.

In certain embodiments, compositions of the present invention comprise solubilized active ingredients incorporated into the micronized carrier.

In an aspect, one or more insecticidal dusts is/are incorporated into compositions of the present invention to increase bioavailability of the carrier on microscopically porous substrates and serves to extend residual efficacy as any insect that passes through the insecticidal dust is exposed to both insecticidal carrier and solubilized or suspended active ingredient(s).

Additionally, in an aspect, the carrier also adds to the efficacy as the carrier itself has insecticidal properties, with differing modes of action, such as desiccating properties, which dry out the insect by absorbing the waxy cuticular layer, leading to insect death, or abrasive properties, or heat properties. It has been surprisingly found that the active ingredients and such carriers, which itself have insecticidal properties, can overcome bed bug resistance when used together. In an aspect, the active ingredient is micronized or solubilized onto the carrier particles.

Furthermore, in an aspect, compositions described herein exhibit enhanced residuality, surface compatibility, and surface bioavailability for all active ingredients comprised therein.

When combined, the carrier and active ingredient(s) can have an unexpected effect, such as the absorption of the waxy cuticular layer of the insect (which normally acts as a barrier to entry for sprayed active ingredient) by the carrier enabling the active ingredients to penetrate into the insect hemolymph more easily, etc. The combined effect is twofold: degradation of the insect cuticle coupled with penetration of active ingredient into the body.

In an aspect, a simple aqueous tank-mix of carrier and active ingredient is not sufficient for simultaneous degradation and penetration. In the instant invention, the active ingredient is micronized or solubilized onto the carrier particles, thus achieving simultaneous degradation and penetration of carrier and active ingredient(s) into the insect at each contact point. By combining one or more active ingredients with a carrier in such a way that the active ingredient(s) are micronized or solubilized onto then carrier particles, for example, a silica carrier, improved insecticidal efficacy is achieved. By contrast, a formulation in which active ingredient(s) and silica are all micronized as a traditional suspension concentrate would not deliver the same efficacy because the silica would no longer be serving as a carrier for the active ingredient(s); a bed bug or other insect/pest would interact with the silica and active(s) separately at different contact points in such a traditional suspension concentrate. Compositions of the present invention, however, achieve true combination and therefore simultaneity of contact of silica and active ingredient with the target pest.

In certain embodiments, compositions of the present invention comprise a solid carrier without a liquid component. In an aspect, such embodiments could be dusted or otherwise spread without the use of spraying, eliminating the need for incorporation into a liquid. In certain embodiments, compositions described herein are dust formulations.

The composition can be a concentrate or a ready-to-use composition. A concentrate refers to a composition that is diluted to form the ready-to-use composition. A ready-to-use composition refers to the composition that is applied to a target. A concentrate composition can be diluted before use, for example in a ratio of 1:2, 1:3, 1:4, 1:5, 1:10, 1:20, 1:50, 1:99, or any other suitable ratio that results in an effective amount of active ingredients (pheromone components and/or pesticides) in the diluted solution.

In certain embodiments, compositions of the present invention are formulated as an aqueous silica suspension formulation.

In certain embodiments, compositions of the present invention comprise a solid carrier incorporated into a liquid that can be sprayed. Incorporation into a liquid would preserve the beneficial properties of compositions described herein (i.e., improved surface bioavailability, surface compatibility, and residuality). Incorporation into a sprayable liquid formulation would further allow for more use patterns, more specific dosing, and support of a wider range of application rates.

In certain embodiments, compositions described herein are suspension concentrate formulations.

In certain embodiments, compositions described herein are carrier-based suspension concentrate formulations.

In an aspect, the inert carrier selected possesses insecticidal activity owing to desiccating effects, abrasive effects, or heat effects.

In certain embodiments, the carrier is silica or any silica-based or silica-derived carrier.

Suitable solid carriers are, for example, ground natural minerals, such as kaolins, clays, talc, chalk, quartz, attapulgite, montmorillonite or diatomaceous earth, and ground synthetic minerals, such as finely divided silica, alumina and silicates. Suitable solid carriers for granules are, for example, crushed and fractionated natural rocks such as calcite, pumice, marble, sepiolite and dolomite, and also synthetic granules of inorganic and organic meals, and granules of organic material such as sawdust, coconut shells, maize cobs and tobacco stalks.

In certain embodiments, regardless of whether the carrier is incorporated into a liquid component, the carrier is silica aerogel, amorphous silica, microporous silica, talc, diatomaceous earth, clay, defatted or dehydrated corn grits, calcium carbonate, aluminumhydrosilicate (kaolinite) and/or gypsum.

In an aspect, any solvent and surfactant may be used to prepare compositions according to the present invention.

In an aspect, any solvent may be employed to incorporate the solid component into a sprayable formulation.

In certain embodiments, the solvent is a water-immiscible, low-volatility organic solvent.

In certain embodiments, the solvent is N,N-dimethyl (octanamide/decanamide).

In other embodiments, the solvent is 1-Octyl-2-pyrrolidone, benzyl acetate, benzyl benzoate, 2-ethylhexyl lactate, dibutyl isosorbide, cyclohexanone, propylene glycol phenyl ether, and combinations and/or derivatives thereof.

In certain embodiments, the solvent is a non-ionic and anionic emulsifiers, such as polyoxyethylene fatty acid esters, polyoxyethylene fatty alcohol ethers, for example alkylaryl polyglycol ethers, alkylsulphonates, alkyl sulphates, arylsulphonates and protein hydrolysates. As dispersants, for example, lignosulphite waste liquors and methylcellulose are suitable.

In an aspect, surfactants can be used to aid solubility of the composition or of the components of the composition, and to improve homogeneity of the composition. Surfactants may also be used to lower surface tension and to aid the application of the composition, e.g., by spraying. Suitable surfactants include, for example non-ionic, cationic, anionic, zwitterionic (amphoteric), or semi-polar non-ionic surfactants and combinations thereof. Exemplary emulsifiers include fatty carboxylic acids, fatty carboxylic acid salts, and esters of fatty carboxylic acids, such as polyglyceryl oleate, polyglyceryl stearate, or lecithin. The surfactants can be selected based on the intended use of the composition. For example, a surfactant can be incorporated into the composition to improve solubility of active ingredients, to form an emulsion, to improve wettability, or other similar purposes. The composition may comprise about 0-20 wt-% surfactants, or about 0.5-15 wt-% surfactants. For example, suitable surfactants include, but are not limited to, polyoxyethylene and/or polyoxypropylene of sorbitol oleates, block copolymers of polyoxyethylene and polyoxypropylene, tristyrylphenol ethoxylate/propoxylate, polyoxyetheylene castor oil, alkoxylated phosphate esters and combinations and/or derivatives thereof.

In an aspect, any insecticidal active ingredient may be used according to the present invention. Suitable active ingredients include:

Pyrethroid compounds such as dd-T-cyphenothrin, acrinathrin, permethrin phenothrin, d-phenothrin, allethrin, d-allethrin, dd-allethrin, pyrethrin, prallethrin, cyphenothrin, cyfluthrin, beta-cyfluthrin, bifenthrin, cycloprothrin, cyhalothrin, lambda-cyhalothrin, gamma-cyhalothrin, cypermethrin, sigma-cypermethrin, alpha-cypermethrin, zeta-cypermethrin, dimefluthrin, empenthrin, deltamethrin, terallethrin, tefluthrin, fenvalerate, esfenvalerate, flucythrinate, flufenprox, flumethrin, fluvalinate, tau-fluvalinate, profluthrin, halfenprox, imiprothrin, benfluthrin, resmethrin, d-resmethrin, silafluofen, tralomethrin, tetramethrin, d-ttetramethrin, furamethrin, metoflutrin, fenpropathrin, transfluthrin, or etofenprox;

Organophosphorus compounds such as acephate, butathiofos, chlorethoxyfos, chlorfenvinphos, chlorpyrifos, chlorpyrifos-methyl, cyanophos, diazinon, bis(2-chloroisopropyl)ether (DCIP), dichlofenthion, dichlorvos, dimethoate, dimethylvinphos, disulfoton, o-ethyl-o-(4-nitrophenyl)phenylphosphonothioate (EPN), ethion, ethoprophos, etrimfos, fenthion, fenitrothion, fosthiazate, formothion, isofenphos, isoxathion, malathion, mesulfenfos, methidathion, monocrotophos, naled, parathion, phosalone, phosmet, pirimiphos-methyl, pyridaphenthion, quinalphos, phenthoate, profenofos, propaphos, prothiofos, pyraclofos, salithion, sulprofos, temefos, terbufos, trichlorfon, or cadusafos;

N-phenylpyrazole compounds such as fipronil;

Carbamate compounds such as propoxur, alanycarb, benfuracarb, Bassa (BPMC), carbaryl, carbofuran, carbosulfan, cloethocarb, ethiofencarb, fenobucarb, methomyl, methiocarb, Carbaryl (NAC), oxamyl, pirimicarb, 3,5-xylyl methylcarbamate (XMC), thiodicarb, xylycarb, or aldicarb;

Oxadiazole compound such as metoxadiazone;

Neonicotinoid compound such as imidacloprid, clothianidin, thiamethoxam, dinotefuran, acetamiprid, nitenpyram, or thiacloprid;

Insect growth regulators such as pyriproxyfen, methoprene, hydroplane, fenoxycarb, etoxazole, chlorfluazuron, triazuron, novaluron, hexaflumuron, difhibenzuron, cyromazine, flufenoxuron, teflubenzuron, triflumuron, or lufenuron;

Macrolide compounds such as milbemycin, abamectin, or ivermectin; and

Diamide compounds such as chlorantraniliprole, cyantraniliprole, cyclaniliprole, tetraniliprole, flubendiamide, or cyhalodiamide.

In certain embodiments, the active ingredient is a sodium channel blocker.

In certain embodiments, the active ingredient is a pyrethroid.

In certain embodiments, the active ingredient is alpha-cypermethrin, cyfluthrin, beta-cyfluthrin, esfenvalerate, phenothrin, cyhalothrin, gamma-cyhalothrin, lambda-cyhalothrin, bifenthrin, or a combination thereof.

In certain embodiments, the active ingredient is a nicotinic receptor agonist.

In certain embodiments, the active ingredient is a neonicotinoid such asimidacloprid, thiamethoxam, acetamiprid, nitenpyram, thiacloprid, flupyradifurone, dinotefuran, clothianidin, or a combination thereof.

In certain embodiments, compositions described herein comprise a combination of two or more active ingredients.

In certain embodiments, compositions of the present invention comprise both a sodium channel blocker and a nicotinic receptor agonist as active ingredients. In an aspect, the sodium channel blocker is a pyrethroid and the nicotinic receptor agonist is a neonicotinoid. In certain embodiments, the sodium channel blocker is alpha-cypermethrin, cyfluthrin, beta-cyfluthrin, esfenvalerate, phenothrin, cyhalothrin, gamma-cyhalothrin, lambda-cyhalothrin, bifenthrin, or a combination thereof. In certain embodiments, the nicotinic receptor agonist is imidacloprid, thiamethoxam, flupyradifurone, dinotefuran, clothianidin, or a combination thereof.

In an aspect, the amounts, concentrations, and application rates of sodium channel blocker(s) or nicotinic receptor agonist(s), and the total amount of composition to be employed, depend on the particular insect pest strain and the occurrence of the pest. The optimal ratios and overall rates used can be determined for each application by test series.

In an aspect, compositions of the present invention comprise a sodium channel blocker at a concentration of 0.0001 mg/m² to 1000 mg/m², or 0.0005 mg/m² to 500 mg/m², or 0.001 mg/m² to 250 mg/m², or 0.005 mg/m² to 100 mg/m².

In an aspect, compositions of the present invention comprise a nicotinic receptor agonist at a concentration of 0.0001 mg/m² to 1000 mg/m², or 0.0005 mg/m² to 500 mg/m², or 0.001 mg/m² to 250 mg/m², or 0.005 mg/m² to 100 mg/m².

In an aspect, compositions of the present invention comprising both a sodium channel blocker (“SCB”) and a nicotinic receptor agonist (“NRA”) comprise a SCB and a NRA at a ratio SCB:NRA of 1:200 to 200:1, or 1:100 to 100:1, or 1:50 to 50:1, or 1:25 to 25:1, or 1:10 to 10:1.

In an aspect, the disclosure provides for a method of preventing or controlling insects or pests comprising applying the compositions discussed herein to the insect, surface, or object to be treated.

In an aspect, according to a method of the present invention, a composition described herein is applied to a surface or other area at an application rate of 0.0001 mg/m² to 1000 mg/m², or 0.0005 mg/m² to 500 mg/m², or 0.001 mg/m² to 250 mg/m², or 0.005 mg/m² to 100 mg/m².

Combination of pyrethroids with nicotinic receptor agonists achieves effective insecticidal activity because nicotinic receptor agonists increase sodium channel opening, thereby increasing the uptake of molecules that act upon the sodium channel Previous products have combined pyrethroid and neonicotinoid active ingredients together in a formulation of suspended micronized active ingredients. However, these combination products have not overcome all forms of resistance seen in select bedbug strains. Compositions of the present invention differ in that, in certain embodiments, one or more solubilized active ingredients is/are combined with an inert carrier.

Formulations described herein can be dusted or sprayed onto a surface. If sprayed, the liquid application dries leaving behind an insecticidal dust residue. Insecticide dusts are known for their outstanding residual efficacy.

Incorporation of a dust into a spray product is heretofore unseen in the pest control industry for control of insects such as bed bugs. Furthermore, the specific combination of carrier dust, such as silica dust and the active ingredients brings about resistance breaking behavior that is not otherwise seen from the dust, nor the AIs, separately.

In certain embodiments, compositions of the present invention comprise active ingredients in addition to a sodium channel blocker and/or nicotinic receptor agonist. In an aspect, any additional insecticidal or biocidal active ingredient may be present in the composition.

In certain embodiments, compositions of the present invention further comprise as active ingredients one or more active ingredients selected from diamide/pyridylpyrazole, broflanilide, chlorantraniliprole, cyantraniliprole, tetraniliprole, isooxazoline, afoxalaner, fluralaner, fluxametamide, oxadiazine/semicarbazone, indoxacarb, and metaflumizone.

In certain embodiments, a composition of the present invention may be formulated with an emulsifier in suspoemulsion.

The disclosure further provides for a method of preparing sprayable dust formulations of compositions described herein. The order and method of combination is important in the performance of the final product.

In an aspect, for preparation of certain embodiments of the present invention, a traditional emulsifiable concentrate is first prepared, comprising solvent(s), surfactant(s), and active ingredient(s). In an aspect, a mixer may be employed.

Next, a carrier is added and incorporated into the emulsifiable concentrate under moderate to high shear. Over time, the emulsifiable concentrate is fully adsorbed into the carrier. In an aspect, a high-shear mixer may be employed.

Next, a carrier is suspended in the emulsifiable concentrate. In an aspect, a high-shear mixer may be employed.

In an aspect, carrier particles, such as silica particles, used for preparation of compositions of the present invention may be of any particle size and any pore size.

In an aspect, traditional means of production may be employed to prepare an emulsifiable concentrate comprising mixing one or more solvent(s), one or more surfactant(s), and one or more active ingredient(s).

For preparation of a sprayable formulation, dilution in water or other sprayable solvent is lastly performed. Upon dilution into a spray tank with water, the emulsifiable concentrate forms an emulsion in water. The carrier remains suspended in the spray tank, with little of the emulsifiable concentrate desorbed from the silica aerogel, owing to the long times required for the sorption/desorption kinetics. Such times for sorption/desorption are dependent on properties such as the pore size of the carrier, the steric bulk of the surfactants used, and the binding coefficients between the emulsifiable concentrate solvents and the carrier.

In an aspect, any pests or insect may be controlled by the compositions and/or methods taught herein. Some embodiments of the present invention can be used to control pests such as arthropods, including insects and arachnids. Exemplary pests include arthropods such as insects, spiders, centipedes and millipedes, bed bugs, German cockroaches (Blattella germanica), Smoky Brown cockroaches (Periplaneta fuliginosa), American cockroaches (Periplaneta americana), cat fleas (Ctenocephalides felis), fire ants (Solenopsis invicta), black carpenter ants (Camponotus pennsylvanicus), pavement ants (Tetramorium caespitum), field ants (Formica sp.), moisture ants (Lasius sp.), wood ants (Formica rufa), house flies (Musca domestica), bottle flies (Lucilia sericata), giant silverfish (Ctenolepisma longicaudata), firebrats (Thermobia domestica), bean aphids (Aphis fabae), pea aphids (Acyrthosiphon pisum), termites (Reticulitermes flavipes), granary weevils (Sitophilus granarius), maize weevils (Sitophilus zeamais), confused flour beetles (Tribolium confusum), rusty grain beetles (Cryptolestes ferrugineus), dust mites (Dermatophagoides farinae), millipedes (Cylindroiulus caeruleocinctus), centipedes (Strigamia aluminata), sowbugs (Oniscus asellus), orabatid mites (Haplozetes sp.), house crickets (Acheta domestica), black widow spiders (Latrodectus mactans), brown recluse spiders (Loxosceles reclusa), and pharaoh ants (Monomorium pharaonis). Exemplary pests include arthropod eggs, including bed bug eggs and cockroach eggs. Other exemplary pests can include, but not limited to, whiteflies, mosquitoes, other species of flies, other species of aphids, other species of silverfish, lice, stink bugs, moths, beetles, lace bugs, whiteflies, green peach aphids, western floral thrips, diamondback moths, leafminers, grasshoppers, crickets, locusts, leafhoppers, planthoppers, psyllids, scale insects, midges, fruit flies, earworms, bollworms, armyworms, budworms, hornworms, milkweed bugs, mealy bugs, weevils, botflies, face flies, sawflies, rice bugs, coffee bugs, vegetable bugs, corn borers, horn flies, blowflies, sowbugs, pillbugs, mites, centipedes and millipedes. Exemplary pests also include arachnids including cellar spiders, ticks, black widow spiders and brown recluse spiders. Possible pests can also include, but not limited to, scorpions and other species of spiders. This disclosure is intended to encompass uses against all of the above, as well as uses against other pests, including other insects and arachnids, and other organisms including fungi, bacteria, viruses, and nematodes.

In some embodiments, the pesticidal compositions described herein are effective to kill and/or control pests and/or prevent or reduce oviposition and/or prevent or reduce eclosion of their eggs. In some embodiments, the pesticidal compositions described herein exhibit effective knockdown pesticidal activity, exhibit effective dry residue pesticidal activity, and/or exhibit effective prolonged residual pesticidal activity.

Some embodiments of the present invention can be used to control pests that affect humans and non-human mammals including bed bugs, cockroaches, lice, fleas, ticks, mites, and scabies. Some embodiments of the present invention can be used to control pests that affect plants or agriculture, such as aphids or nematodes.

In certain embodiments, the insects controlled by compositions and/or methods taught herein are bed bugs.

As used herein with respect to insects and in particular with respect to bed bugs, term “control” refers to the possibility to be able to kill and/or repel insects and/or bed bugs.

In another aspect, bed bugs controlled by the compositions and/or methods taught herein include, but are not limited to, insects belonging to the Cimex genus.

In yet another aspect, bed bugs controlled by compositions and/or methods taught herein include, but are not limited to, the species Cimex lectularius and Cimex hemipterus.

The active compound combination according to the invention may comprise further components, for example additional active compounds of a different type (e.g., other insecticides, antibacterial compounds, fungicides, herbicides etc.) and/or additives customary in crop protection and/or formulation auxiliaries, or may be used together with these compounds.

In an aspect, a composition according to the present invention may comprise one or more biocides. In an aspect, any commercially available biocide may be used. For example, PROXEL™ GXL (20%) provided by Arch chemical (see excelind.co.in/Excel_Chemical/download/Proxel_GXL_literature.pdf), and KATHON™ CG/ICP is provided by DuPont (see dupont.com/products/kathoncgicp.html).

A formulation disclosed herein may optionally include one or more additional compounds providing an additional beneficial or otherwise useful effect. Such compounds include, without limitation, an adhesive, a surfactant, a solvent, a wetting agent, an emulsifying agent, a carrier, an adjuvant, a diluent, a dispersing agent, an insecticide, a pesticide, a fungicide, a fertilizer of a micronutrient or macronutrient nature, a herbicide, a feeding inhibitor, an insect molting inhibitor, an insect mating inhibitor, an insect maturation inhibitor, a nematacide, a nutritional or horticultural supplement, or any combination thereof.

In an aspect, a suspension formulation according to the present invention may comprise one or more wetting agents or dispersants. In an aspect, any commercially available wetting agent or dispersant may be used.

The disclosure further provides for methods of making and using dustable formulations of the present invention.

The disclosure further provides for methods of making and using suspension formulations of the present invention.

In certain embodiments, the active ingredient(s) is/are micronized or solubilized into the carrier.

In certain embodiments, the active ingredient(s) is/are micronized or solubilized into the liquid solution.

In certain embodiments, the active ingredient(s) is/are micronized or solubilized into the carrier and into the liquid solution.

In an aspect, compositions of the present invention may further comprise or otherwise incorporate other dusts. In another aspect, such additional dusts may be incorporated or otherwise added in the form of free micronized active ingredients, either solubilized with a carrier or not solubilized with a carrier. In yet another aspect, other embodiments may include combinations of both micronized and solubilized active ingredients with the carrier.

These formulations are produced in any desired or known manner, for example by mixing the active compounds with extenders, such as liquid solvents, pressurized liquefied gases and/or solid carriers, optionally with the use of surface-active agents, such as emulsifiers and/or dispersants and/or foam formers. If the extender used is water, it is also useful to employ for example organic solvents as cosolvents. Suitable liquid solvents include, without limitation: aromatics, such as xylene, toluene or alkylnaphthalenes, chlorinated aromatics or chlorinated aliphatic hydrocarbons, such as chlorobenzenes, chloroethylenes or methylene chloride, aliphatic hydrocarbons, such as cyclohexane or paraffins, for example mineral oil fractions, alcohols, such as butanol or glycol as well as their ethers and esters, ketones, such as acetone, methyl ethyl ketone, methyl isobutyl ketone or cyclohexanone, strongly polar solvents, such as dimethylformamide and dimethyl sulphoxide, and also water. Liquefied gaseous extenders or carriers include those liquids which are gaseous at ambient temperature and at atmospheric pressure, for example aerosol propellants such as halogenated hydrocarbons and also butane, propane, nitrogen and carbon dioxide. As solid carriers there are suitable: for example, ground natural minerals, such as kaolins, clays, talc, chalk, quartz, attapulgite, montmorillonite or diatomaceous earth, and ground synthetic minerals, such as finely divided silica, alumina and silicates. As solid carriers for granules there are suitable: for example, crushed and fractionated natural rocks such as calcite, pumice, marble, sepiolite and dolomite, and also synthetic granules of inorganic and organic meals, and granules of organic material such as sawdust, coconut shells, maize cobs and tobacco stalks. As emulsifiers and/or foam formers there are suitable: for example, non-ionic and anionic emulsifiers, such as polyoxyethylene fatty acid esters, polyoxyethylene fatty alcohol ethers, for example alkylaryl polyglycol ethers, alkylsulphonates, alkyl sulphates, arylsulphonates and protein hydrolysates. As dispersants, for example, lignosulphite waste liquors and methylcellulose are suitable.

Tackifiers such as carboxymethylcellulose and natural and synthetic polymers in the form of powders, granules or latices, such as gum arabic, polyvinyl alcohol and polyvinyl acetate, as well as natural phospholipids, such as cephalins and lecithins, and synthetic phospholipids, can be used in the formulations. Other possible additives are mineral and vegetable oils.

Colorants such as inorganic pigments, for example iron oxide, titanium oxide and Prussian Blue, and organic dyestuffs, such as alizarin dyestuffs, azo dyestuffs and metal phthalocyanine dyestuffs, and trace nutrients such as salts of iron, manganese, boron, copper, cobalt, molybdenum and zinc, can also be used.

The active compound combination according to the invention may comprise further components, for example additional active compounds of a different type (e.g., other insecticides, antibacterial compounds, fungicides, herbicides, etc.) and/or additives customary in crop protection and/or formulation auxiliaries, or may be used together with these compounds. However, the active compound combination according to the invention does not comprise piperonyl butoxide (PBO).

These formulations are produced in a known manner, for example by mixing the active compounds/active compound combination with extenders, that is liquid solvents and/or solid carriers, optionally with the use of surfactants, that is emulsifiers and/or dispersants, adjuvants, that is substances which improve the biological performance without having an own biological activity, antifoam, preservatives, antioxidants, colourants, anti-freeze, pH stabilizers, thickeners, and/or foam-formers.

Alternatively, in another embodiment of the invention, the active compound combination is used to control bed bugs via an ovicidial activity. For this purpose, the active compound combination of the invention is applied to (e.g., sprayed on or dusted) bed bugs and eggs directly (e.g., on bedsprings, box springs, and the interior of bed frames or headboards, including all cracks and joints).

Additionally, suitable for use as optional auxiliaries are substances which are suitable for imparting to the active compounds/active compound combination itself and/or to preparations derived therefrom (for example spray liquors, seed dressings) particular properties such as certain technical properties and/or also particular biological properties. Typical suitable auxiliaries are: extenders, solvents and carriers.

Suitable extenders are, for example, water, polar and nonpolar organic chemical liquids, for example from the classes of the aromatic and non-aromatic hydrocarbons (such as paraffins, alkylbenzenes, alkylnaphthalenes, chlorobenzenes), the alcohols and polyols (which, if appropriate, may also be substituted, etherified and/or esterified), the ketones (such as acetone, cyclohexanone), esters (including fats and oils) and (poly)ethers, the unsubstituted and substituted amines, amides, lactams (such as N-alkylpyrrolidones) and lactones, the sulphones and sulphoxides (such as dimethyl sulphoxide).

If the extender used is water, it is also possible to employ, for example, organic solvents as auxiliary solvents. Essentially, suitable liquid solvents are: aromatics such as xylene, toluene or alkylnaphthalenes, chlorinated aromatics and chlorinated aliphatic hydrocarbons such as chlorobenzenes, chloroethylenes or methylene chloride, aliphatic hydrocarbons such as cyclohexane or paraffins, for example petroleum fractions, mineral and vegetable oils, alcohols such as butanol or glycol and also their ethers and esters, ketones such as acetone, methyl ethyl ketone, methyl isobutyl ketone or cyclohexanone, strongly polar solvents such as dimethylformamide and dimethyl sulphoxide, and also water.

Suitable solid carriers are: for example, ammonium salts and ground natural minerals such as kaolins, clays, talc, chalk, quartz, attapulgite, montmorillonite or diatomaceous earth, and ground synthetic minerals, such as finely divided silica, alumina and silicates; suitable solid carriers for granules are: for example, crushed and fractionated natural rocks such as calcite, marble, pumice, sepiolite and dolomite, and also synthetic granules of inorganic and organic meals, and granules of organic material such as paper, sawdust, coconut shells, maize cobs and tobacco stalks; suitable emulsifiers and/or foam-formers are: for example, nonionic and anionic emulsifiers, such as polyoxyethylene fatty acid esters, polyoxyethylene fatty alcohol ethers, for example alkylaryl polyglycol ethers, alkylsulphonates, alkyl sulphates, arylsulphonates and also protein hydrolyzates; suitable dispersants are nonionic and/or ionic substances, for example from the classes of the alcohol-POE- and/or -POP-ethers, acid and/or POP-POE esters, alkyl aryl and/or POP-POE ethers, fat- and/or POP-POE adducts, POE- and/or POP-polyol derivatives, POE- and/or POP-sorbitan- or -sugar adducts, alkyl or aryl sulphates, alkyl- or arylsulphonates and alkyl or aryl phosphates or the corresponding PO-ether adducts. Furthermore, suitable oligo- or polymers, for example those derived from vinylic monomers, from acrylic acid, from EO and/or PO alone or in combination with, for example, (poly)alcohols or (poly)amines It is also possible to employ lignin and its sulphonic acid derivatives, unmodified and modified celluloses, aromatic and/or aliphatic sulphonic acids and their adducts with formaldehyde.

A composition described herein can be applied directly to a site of insect infestation or directly to insects themselves.

A composition described herein can be applied directly to a site or area as a preventative treatment. For example, a composition described herein can be applied to kill insects that cross or otherwise pass through a treated area.

The disclosed compositions can be used on a variety of surfaces and in a variety of locations. In an aspect, a formulation described herein can be applied directly to a wall, surface, flooring, carpet, mattress, clothing, luggage, or to sheets, pillows and other bedding. For example, the disclosed compositions can be used to treat surfaces, textiles, furniture, and structures, including mattresses, box springs, beds, bed frames, cushions, chairs, sofas, seats, and other upholstered furniture, booths; textiles, carpets, rugs, clothing, and toys; closets, dressers, cabinets, drawers, tables, etc.; personal items, books, electronics, picture frames, etc.; cracks and crevasses between floor boards, behind base boards, head boards, furniture, and wall paper. The composition may be used, for example, in residential and lodging structures (e.g., homes, multi-family residences, dormitories, hotels, motels, hostels, etc.), food service facilities (e.g., restaurants, cafes, cafeterias, mess halls, etc.), offices, government buildings, military facilities, transportation vehicles (e.g., buses, trains, airplanes, cars, etc.), vessels (e.g., boats, submarines, cruise liners, ships, ferries, etc.), homeless shelters, entertainment facilities (e.g., theaters, movie theaters, casinos, etc.), or in patient rooms and common areas in healthcare and long-term care facilities. The compositions can be used to treat the entrances to buildings, around drive through windows, road surfaces near drive through windows, or the concrete or dumpster containers outside of buildings. In general, the composition may be used in any location occupied by people, or where belongings could be placed and bed bugs may have an opportunity to transfer from a person or his/her belongings to the surroundings.

In an aspect, a composition described herein may be applied in a single application step. In another aspect, a composition described herein may be applied in multiple application steps, for example, two, three, four, five or more application steps. In another aspect, the second, third, fourth, or fifth or more application steps may be with the same or different formulations. The methods described herein also provide for an aspect where multiple application steps are excluded.

A formulation described herein can be applied to insects or a site or object to be treated in one or more application intervals of about 15 minutes, 30 minutes, about 1 hour, about 2 hours, about 6 hours, about 8 hours, about 12 hours, about 1 day, about 5 days, about 7 days, about 10 days, about 12 days, about 14 days, about 21 days, about 28 days, about 35 days, about 40 days, about 45 days, about 50 days, or about 56 days.

A formulation described herein can be applied to insects or a site or object to be treated after insects have been observed to kill, repel, or otherwise control identified insects. Alternatively, a composition described herein can be applied to a site or object to be treated before any insects have been observed as a preventative measure to kill, repel, or otherwise control insects not yet identified.

A further embodiment of this invention relates to the use of the above described compositions and/or materials to control animal pests, preferably arthropods, preferably insects and more preferably bed bugs including insecticide-resistant bed bugs and bed bugs that are target-site- and/or metabolic-resistant. In another preferred embodiment the current invention relates to the use of such a material to control pyrethroid and/or carbamate-resistant mosquitos, preferably pyrethroid and/or carbamate-resistant Anopheles gambiae and/or Anopheles funestus mosquitos. In an aspect, the compositions and materials of the present invention is used to control pyrethroid-resistant insect. Another preferred embodiment of the invention relates to the use of such a material to control multi-resistant mosquitos.

In another embodiment of the invention the active compound composition of the invention are used to control insecticide-resistant insects, in an aspect insecticide-resistant bed bugs. The term “insecticide-resistance” is the term used to describe the situation in which the target insects or bed bugs are no longer killed by the standard dose of insecticide (i.e., they are no longer susceptible to the insecticide) or manage to avoid coming into contact with the insecticide). See 1.2.; p. 27; “Global Plan for Insecticide Resistance Management”, WHO 2012).

In an aspect, certain embodiments of the present invention also relate to the use of the above described compositions and/or materials to control pyrethroid-resistant bed bugs. In an embodiment, the material is used to control pyrethroid-resistant bed bugs, wherein the bed bugs have a Valine to Leucine mutation (V419L) and/or a Leucine to Isoleucine mutation (L925I) in the voltage-gated sodium channel alpha-subunit gene.

In an aspect, a formulation described herein is combined with a talc and/or graphite. In an aspect, a composition or method described herein does not include talc. In another aspect, a formulation or method described herein does not include graphite or graphite blends. In yet another aspect, a formulation or method described herein does not include blends of graphite and/or talc. In another aspect, a formulation or method described herein contains trace amount of talc or graphite. In another aspect, a formulation or method described herein contains less than about 5%, less than about 10%, less than about 20%, less than about 20%, less than about 30%, less than about 40%, or less than about 50% by weight of talc, graphite, or a combination of talc or graphite.

In yet another aspect, a formulation described herein may be blended with inert materials to improve handling or packaging, for example, silica, starches (natural and derived), clays, and other minerals.

### EXAMPLES

The following examples serve to illustrate certain aspects of the disclosure and are not intended to limit the disclosure.

### Example 1

### Testing on Cockroaches

An Emulsifiable Concentrate (EC) was used as the template to illustrate the enhancements of the invention. One comparative EC was created in standard fashion (hereinafter called “No dust”), where to a vessel the solvent, surfactants, active ingredients, and other inerts were added and homogenized with simple mixing.

A second EC, mirroring the creation of the first, was also formulated. But this EC added amorphous silica and a suspending aid to the end step to obtain the liquid dust formulation according to the invention.

TABLE 1

| | | Comparative |
|---|---|---|
| | Liquid Dust | Formulation |
| | Formulation | (No dust) |
| Component | % w/w | % w/w |
| Flupyradifurone | 3.00% | 3.00% |
| Beta-Cyfluthrin | 1.50% | 1.50% |
| Piperonyl Butoxide | 3.00% | 3.00% |
| Benzyl Acetate | 82.35% | 73.00% |
| Ethoxylated Castor Oil with 30 EO | 4.00% | 4.00% |
| Polyoxyethylene-polyoxypropylene block | 2.00% | 2.00% |
| copolymer | | |
| Ethoxylated (16 EO) Tristyrylphenol | 4.00% | 4.00% |
| phosphate, potassium salt | | |
| aqueous emulsion of Polydimethylsiloxane, | 0.10% | 0.10% |
| Y-17259 | | |
| amorphous silica | 0.00% | 9.00% |
| Polyester block copolymer | 0.00% | 0.35% |
| Citric Acid | 0.05% | 0.05% |
| Total | 100.00% | 100.00% |

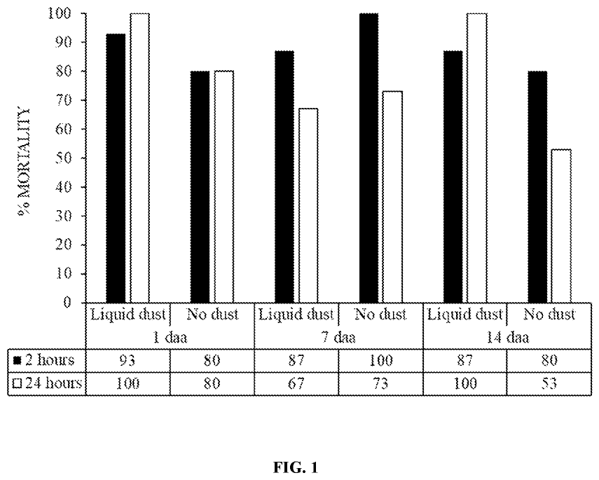

FIG. 1 shows the difference in residual insecticidal activity of the liquid dust formulation against the comparative formulation without the inclusion of dust as described in Table 1. Wood surfaces were sprayed with the formulation (5 mg Beta-Cyfluthrin+10 mg Flupyradifurone)/m²), left to dry completely, then German cockroaches were placed onto the surface for 4 hours, after which time they were removed from the treated surface and placed into a clean container for monitoring. We see that liquid dust formulations according to the invention generally maintained their advantage over the no-dust inclusion control formulations 1 day after application (daa), as well as 7 days and 14 days after application.

### Experiment 2: (Testing on Bed Bugs)

There is no pre-existing formulation type that this invention would fall under. In one vessel, the Flupyradifurone and Beta-cyfluthrin and Citric Acid were dissolved in Benzyl Acetate. This solution was then adsorbed into the amorphous silica. To this silica was added the Polyalkyleneoxide modified Heptamethyltrisiloxane. In a separate vessel, the total amount of water was added. To this was then added the surfactants, biocides, and antifoam, as if building an SC. To this mixture, the silica is then added using a homogenizer with moderate shear. Once fully dispersed, the glycerin and xanthan gum are added to stabilize the solution. The weight ratios (% w/w) used are described in Table 2.

TABLE 2

| Component | % w/w |
|---|---|
| Imidacloprid (98%) | 1.01% |
| Beta-Cyfluthrin (98%) | 0.50% |
| Citric Acid | 0.00% |
| Benzyl Acetate | 8.10% |
| highly dispersed, amorphous Silicon dioxide | 9.88% |
| Polyalkyleneoxide modified Heptamethyltrisiloxane | 0.30% |
| sodium naphthalene sulphonate formaldehyde condensate | 1.00% |
| Sodium polycarboxylate anionic | 1.00% |
| Aqueous emulsion of Polydimethylsiloxane | 0.15% |
| 20% 1,2-Benzisothiazolin-3-on (BIT) as sodium salt | 0.18% |
| Microbicide based on Isothiazolones | 0.08% |
| Citric Acid | 0.02% |
| Glycerin | 8.00% |
| Xanthan Gum | 0.30% |
| Water | 69.48% |
| Total | 100.00% |

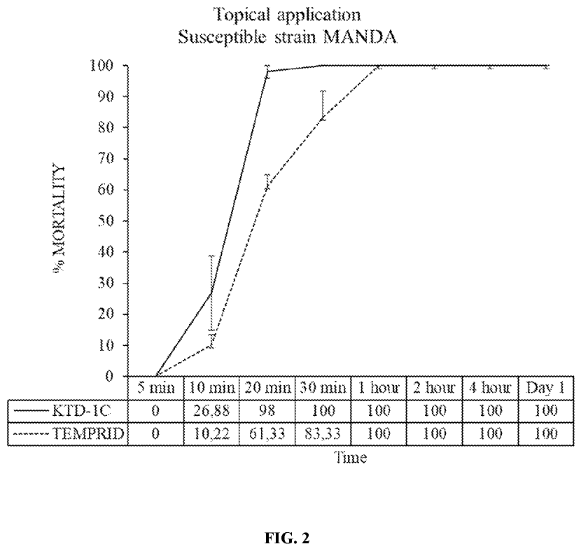

As shown in FIG. 2 a susceptible strain of bed bugs (called the MANDA strain) was sprayed directly with the liquid dust formulation (30 mg ai/m², Beta-Cyfluthrin+Imidacloprid) then monitored for mortality over time. Including dust into the formulation improves the speed of kill of the formulation over the control. As comparative example the commercially available product “TEMPRID® FX” (Bayer CropScience LP) was used (named TEMPRID®). Both formulations have the same concentration of active ingredient, the only difference being the inclusion of the dust in the liquid dust formulation (named KTD-1C).

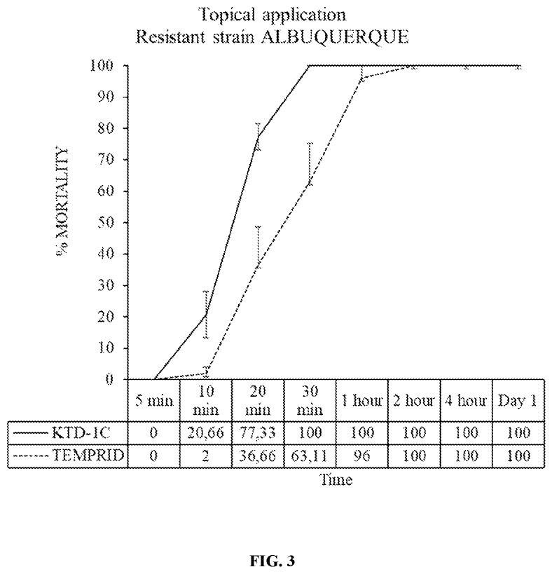

In FIG. 3 a resistant strain of bed bugs (called the ALBUQUERQUE strain) was sprayed directly with the liquid dust formulation (30 mg ai/m², Beta-Cyfluthrin+Imidacloprid) according to the invention. Including dust into the liquid formulation (named KTD-1C) improves the speed of kill of the insecticide formulation compared to the control spray (named TEMPRID®). Both sprays had identical levels of active ingredient, the only difference being the inclusion of dust into the liquid dust formulation (named KTD-1C).

1. An insecticidal composition prepared by, in a first step, preparing an emulsifiable concentrate comprising:
(a) at least one surfactant;
(b) at least one solvent; and
(c) at least one active insecticidal ingredient selected from the group consisting of sodium channel blockers, nicotinic receptor agonists, and combinations thereof; and
in a second step, adding at least one carrier to the emulsifiable concentrate and suspending the carrier into the emulsifiable concentrate.

2. The insecticidal composition according to claim 1, wherein the at least one active insecticidal ingredient is at least one pyrethroid, at least one neonicotinoid, or a combination thereof.

3. The insecticidal composition according to claim 1, wherein the at least one active insecticidal ingredient is selected from the group consisting of alpha-cypermethrin, cyfluthrin, beta-cyfluthrin, esfenvalerate, phenothrin, cyhalothrin, gamma-cyhalothrin, lambda-cyhalothrin, bifenthrin, and combinations thereof.

4. The insecticidal composition according to claim 1, wherein the at least one active insecticidal ingredient is selected from the group consisting of imidacloprid, thiamethoxam, flupyradifurone, dinotefuran, clothianidin, and combinations thereof.

5. The insecticidal composition according to claim 1, wherein the at least one active insecticidal ingredient is a combination of at least one sodium channel blocker and at least one nicotinic receptor agonist.

6. The insecticidal composition according to claim 1, wherein the at least one active insecticidal ingredient comprises
(i) at least one sodium channel blocker selected from the group consisting of alpha-cypermethrin, cyfluthrin, beta-cyfluthrin, esfenvalerate, phenothrin, cyhalothrin, gamma-cyhalothrin, lambda-cyhalothrin, bifenthrin, and combinations thereof; and
(ii) at least one nicotinic receptor agonist selected from the group consisting of imidacloprid, thiamethoxam, flupyradifurone, dinotefuran, clothianidin, and combinations thereof.

7. The insecticidal composition according to claim 5, wherein the sodium channel blocker (“SCB”) and the nicotinic receptor agonist (“NRA”) are present in a ratio SCB:NRA of 1:200 to 200:1, or 1:100 to 100:1, or 1:50 to 50:1, or 1:25 to 25:1, or 1:10 to 10:1.

8. The insecticidal composition according to claim 1, wherein the at least one carrier is selected from the group consisting of silica aerogel, amorphous silica, microporous silica, talc, diatomaceous earth, clay, and combinations thereof.

9. The insecticidal composition according to claim 1, wherein the at least one carrier is selected from the group consisting of silica aerogel, amorphous silica, microporous silica, and combinations thereof.

10. The insecticidal composition according to claim 1, wherein the solvent is selected from the group consisting of N,N-dimethyl (octanamide/decanamide), 1-Octyl-2-pyrrolidone, benzyl acetate, benzyl benzoate, 2-ethylhexyl lactate, dibutyl isosorbide, cyclohexanone, propylene glycol phenyl ether, and combinations and derivatives thereof.

11. The insecticidal composition according to claim 1, wherein the surfactant is selected from the group consisting of polyoxyethylene and polyoxypropylene of sorbitol oleates, block copolymers of polyoxyethylene and polyoxypropylene, tristyrylphenol ethoxylate/propoxylate, polyoxyetheylene castor oil, and alkoxylated phosphate esters.

12. The insecticidal composition according to claim 1, further comprising water.

13. The insecticidal composition according to claim 1, wherein the composition is prepared by in a first step, preparing an emulsifiable concentrate comprising:
(a) at least one surfactant;
(b) at least one solvent; and
(c) at least one active insecticidal ingredient selected from the group consisting of sodium channel blockers, nicotinic receptor agonists, and combinations thereof; and
in a second step, adding at least one carrier to the emulsifiable concentrate and suspending the carrier into the emulsifiable concentrate; and
in a third step, diluting the emulsifiable concentrate in water or other solvent.

14. A method of controlling insects comprising applying to an insect, eggs, surface, or object to be treated a dustable insecticidal composition comprising:
(a) at least one active insecticidal ingredient selected from the group consisting of sodium channel blockers, nicotinic receptor agonists, and combinations thereof;
(b) at least one carrier;
(c) at least one solvent; and
(d) at least one surfactant.

15. The method according to claim 14, wherein the insect is a bed bug.

16. The method according to claim 14, wherein the composition is applied at a rate of from 0.001 mg ai/m² to 1000 mg ai/m², or 0.01 mg ai/m² to 500 mg ai/m², or 0.10 mg ai/m² to 250 mg ai/m², or 0.50 mg ai/m² to 150 mg ai/m².

17. A method of preparing a dust insecticidal composition comprising:
in a first step, preparing an emulsifiable concentrate comprising:
(a) at least one surfactant;
(b) at least one solvent; and
(c) at least one active insecticidal ingredient selected from the group consisting of sodium channel blockers, nicotinic receptor agonists, and combinations thereof; and
in a second step, adding at least one carrier to the emulsifiable concentrate and suspending the carrier into the emulsifiable concentrate.

18. The method according to claim 17, further comprising, in a third step, diluting the emulsifiable concentrate in water or other solvent to prepare a sprayable dust formulation.

19. The insecticidal composition according to claim 1, wherein the at least one carrier is an inert carrier possessing insecticidal activity.

20. The insecticidal composition according to claim 1, wherein the active insecticidal ingredient is micronized or solubilized onto the carrier particles.

21. Use of an insecticidal composition prepared by, in a first step, preparing an emulsifiable concentrate comprising:
(a) at least one surfactant;
(b) at least one solvent; and
(c) at least one active insecticidal ingredient selected from the group consisting of sodium channel blockers, nicotinic receptor agonists, and combinations thereof; and
in a second step, adding at least one carrier to the emulsifiable concentrate and suspending the carrier into the emulsifiable concentrate; and
in a third step, diluting the emulsifiable concentrate in water or other solvent to control insects.
